(19) United States
(12) Patent Application Publication
(10) Pub. No.: US 2020/0267804 A1
(43) Pub. Date: Aug. 20, 2020

(54) USER EQUIPMENT PERFORMING BEAM REPORTING

(71) Applicant: NTT DOCOMO, INC., Tokyo (JP)

(72) Inventors: Yuichi Kakishima, Tokyo (JP); Min Liu, Tokyo (JP); Chongning Na, Tokyo (JP); Satoshi Nagata, Tokyo (JP)

(73) Assignee: NTT DOCOMO, INC., Tokyo (JP)

(21) Appl. No.: 16/651,516

(22) PCT Filed: Sep. 28, 2018
(86) PCT No.: PCT/US2018/053273

§ 371 Date: Mar. 27, 2020

Related U.S. Application Data
(60) Provisional application No. 62/566,112, filed on Sep. 29, 2017.

(51) Int. Cl. H04W 88/06; H04W 72/08; H04W 72/04

(52) U.S. Cl. CPC H04W 88/06; H04W 72/042; H04W 72/046; H04W 72/087

(57) ABSTRACT

A user equipment (UE) includes a receiver that receives, from a base station (B S), multiple reference signals transmitted using first beams, a processor, and a transmitter. The first beams comprise at least one second beam used for Physical Downlink Control Channel (PDCCH) transmission between the BS and the UE and third beams that are not used for the PDCCH transmission. The processor measures quality of the first beams. The transmitter reports, to the BS, the quality of the at least one second beam and part of the third beams.

### TECHNICAL FIELD

One or more embodiments disclosed herein relate to a method of beam management in a wireless communication system and a user equipment that performs beam reporting.

### BACKGROUND

In New Radio (NR; fifth generation (5G) radio access technology) with higher frequency, beamforming technology becomes crucial in order to achieve sufficient coverage and data rate. The beam management scheme has been newly introduced in 3GPP on top of the existing mechanism of Channel State Information (CSI) acquisition in order to efficiently control precoding operation. For massive array system with narrow beams, it is efficient to perform link adaption with multiple steps. More specifically, by taking multiple steps in beam management and CSI acquisition, a gNodeB (gNB) can determine resources for downlink data transmission, which includes precoder, frequency resources, a user equipment (UE) pairs for MU-MIMO, MCS, etc.

Generally, stable transmission of control channel is very crucial compared to data channel and it is beneficial to introduce advanced beam management mechanism for Physical Downlink Control Channel (PDCCH).

In Third Generation Partnership Project (3GPP) Working Group, PDCCH for NR (NR-PDCCH) transmission supporting robustness against beam pair link blocking has been agreed. As shown in FIG. 1, the UE can be configured to monitor NR-PDCCH on different beam pair link(s) in different NR-PDCCH OFDM symbols. Furthermore, parameters related to UE Rx beam setting for monitoring NR-PDCCH on multiple beam pair links are configured by higher layer signaling or MAC CE and/or considered in the search space design.

As shown in FIG. 2, in a PDCCH beam management procedure, reference signals (RSs) used for beam measurement can be periodically transmitted from a gNodeB (gNB) (Tx) to a user equipment (UE) (Rx) to search Transmission (TX)/Reception (RX) beam pairs. Beam measurement results may be reported from the UE to the gNB to select best beams for a PDCCH/Physical Downlink Shared Channel (PDSCH).

After the first beam reporting, the gNB may initialize beams for the PDCCH. A Tx beam ID and a Rx beam ID may be associated with Transmission Configuration Indication (TCI) for purpose of Quasi-Co-Location (QCL) indication. Based on subsequent beam reporting, the gNB may update beams for the PDCCH.

For the PDCCH beam management procedure, information needed by the gNB to update the beams and how to design the beam reporting for support should be clarified.

The following requirements for the PDCCH beam management procedure should be designed:

ensuring PDCCH robustness to avoid unnecessary beam update; and

low reporting overhead.

FIG. 3 is a diagram showing a method of full beam reporting in a conventional scheme 1. In the conventional scheme 1, optimal beam selection may cause the gNB to receive information of all beam combinations. On the other hand, large feedback overhead (e.g., 32 combinations (or 8 combinations if feedback is performed per Tx beam) in the above example) may be caused.

FIG. 4 is a diagram showing a method of unrestricted best-X beam reporting in a conventional scheme 2. According to the conventional scheme 2, overhead can be reduced by reporting only partial beams. On the other hand, unnecessary beams may be updated.

### CITATION LIST

### Non-Patent Reference

[Non-Patent Reference 1] 3GPP, TS 36.211 V 14.4.0

[Non-Patent Reference 2] 3GPP, TS 36.213 V14.4.0

### SUMMARY

One or more embodiments of the present invention relate to a user equipment (UE) that includes a receiver that receives, from the base station (BS), multiple reference signals transmitted using first beams, a processor, and a transmitter. The first beams include at least one second beam used for Physical Downlink Control Channel (PDCCH) transmission between the BS and the UE and third beams that are not used for the PDCCH transmission. The processor measures quality of the first beams. The transmitter reports, to the BS, the quality of the at least one second beam and part of the third beams.

One or more embodiments of the present invention relate to a UE that includes a receiver that receives, from a BS, multiple reference signals transmitted using first beams, a, processor, and a transmitter. The first beams include at least one second beam used for PDCCH transmission between the BS and the UE and third beams that are not used for the PDCCH transmission. The processor measures quality of the first beams. The transmitter reports, to the BS, the quality of part of the third beams.

Other embodiments and advantages of the present invention will be recognized from the description and figures.

### BRIEF DESCRIPTION OF THE DRAWINGS

FIG. 1 is a diagram showing an example of PDCCH transmission for NR.

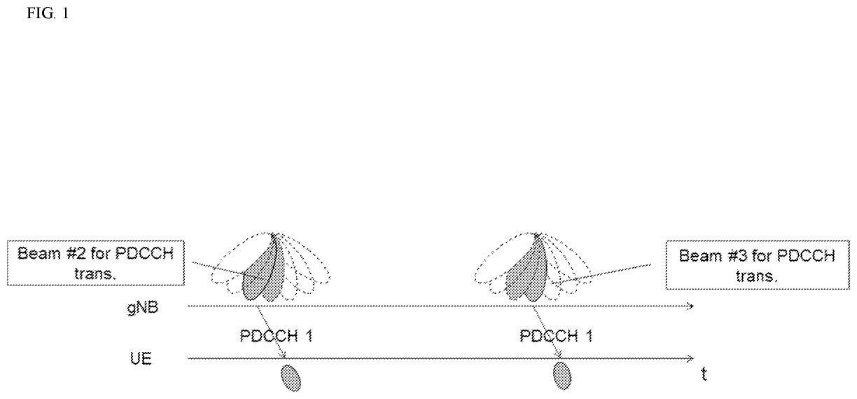

FIG. 2 is a diagram showing an overall PDCCH beam management procedures in the conventional technologies.

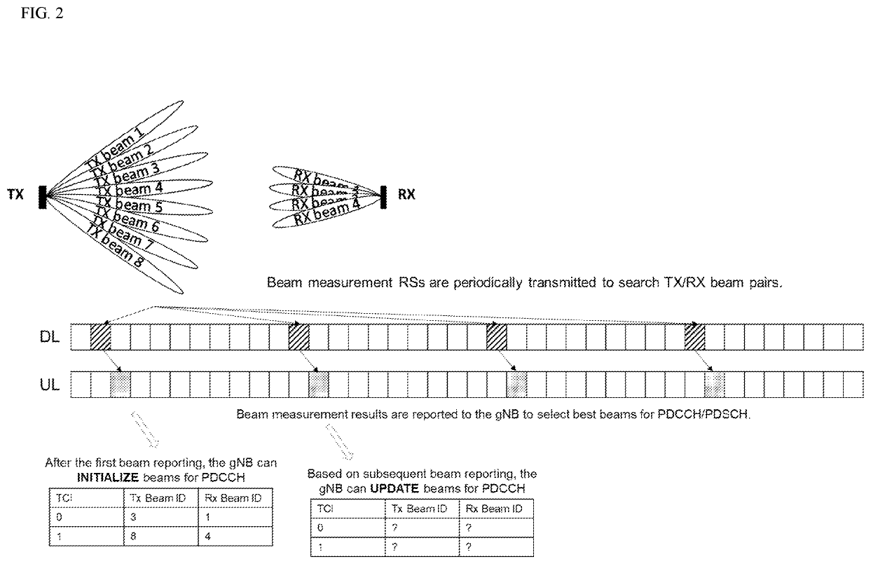

FIG. 3 is a diagram showing a method of full beam reporting in a conventional scheme 1

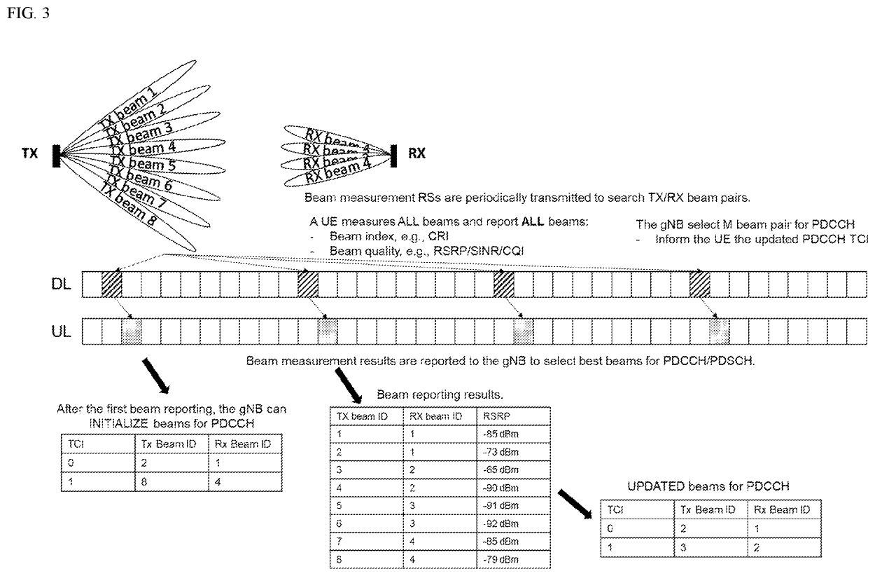

FIG. 4 is a diagram showing a method of unrestricted best-X beam reporting in a conventional scheme 2.

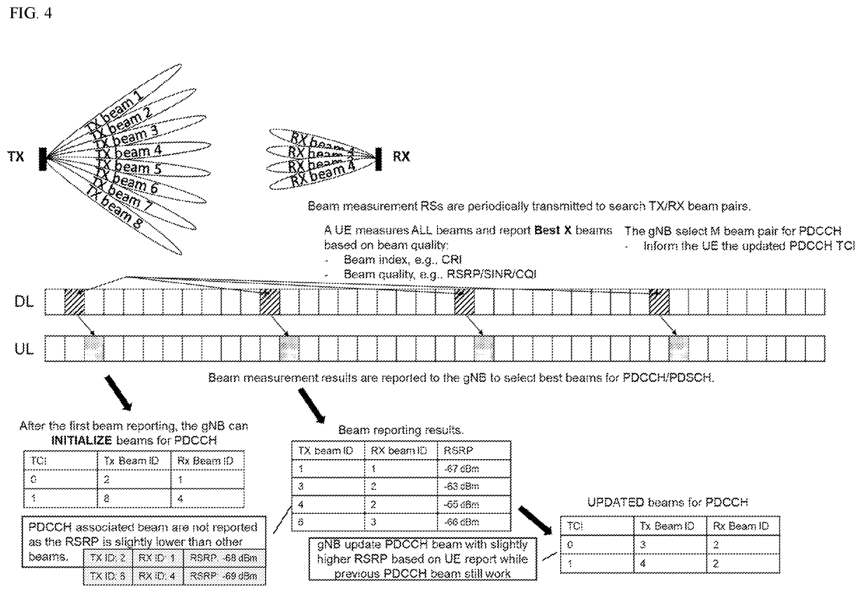

FIG. 5 is a diagram showing a configuration of a wireless communication system according to one or more embodiments of the present invention.

FIG. 6 is a diagram showing a method of restricted beam reporting according to one or more embodiments of a first example of the present invention.

FIG. 7 is a diagram showing a method of restricted beam reporting according to one or more embodiments of a second example of the present invention.

FIG. 8 is a diagram showing further enhancements of beam reporting according to one or more embodiments of the present invention.

FIG. 9 is a diagram showing an example of Option 1 of an enhanced scheme 1 according to one or more embodiments of the present invention.

FIG. 10 is a diagram showing an example of Option 2 of an enhanced scheme 1 according to one or more embodiments of the present invention.

FIG. 11 is a diagram showing an example of an enhanced scheme 2 according to one or more embodiments of the present invention.

FIG. 12 is a diagram showing an example of an enhanced scheme 3 according to one or more embodiments of the present invention.

FIG. 13 is a diagram showing an example of an enhanced scheme 3a according to one or more embodiments of the present invention.

FIG. 14 is a diagram showing an example of an enhanced scheme 3b according to one or more embodiments of the present invention.

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

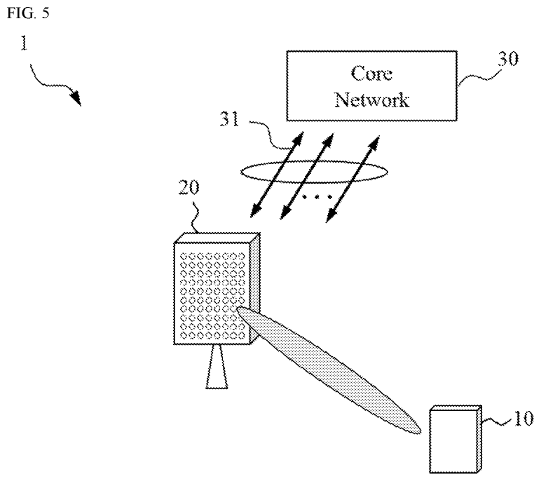

FIG. 5 is a diagram showing a configuration of a wireless communications system 1 according to one or more embodiments of the present invention. The wireless communication system 1 includes a base station (BS) 20, a user equipment (UE) 10, and a core network 30. The wireless communication system 1 may be a New Radio (NR) system. The wireless communication system 1 is not limited to the specific configurations described herein and may be any type of wireless communication system 1 such as an LTE/LTE-Advanced (LTE-A) system. In one or more embodiments of the present invention, the BS 20 and the UE 10 may be referred to as a transceiver (TX) and a receiver (RX), respectively.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links. The BS 20 may be a gNB in a NR system. The BS 20 may be referred to as a transmission and reception point (TRP). For example, when the wireless communications system is an LTE system, the BS 20 may be an evolved NodeB (eNB).

The BS 20 includes antennas, a communication interface to communicate with an adjacent BS 20 (for example, X2 interface), a communication interface to communicate with the core network (for example, Si interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous gNBs 20 may be disposed so as to cover a broader service area of the wireless communication system 1.

The UE may communicate DL and UL signals that include control information and user data with the BS 20 using Multi Input Multi Output (MIMO) technology. The UE may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

In one or more embodiments of the present invention, the beam reporting may be referred to as CSI reporting, CSI-RS Resource Indicator (CRI) reporting, or beam quality reporting.

### First Example: Restricted Beam Reporting

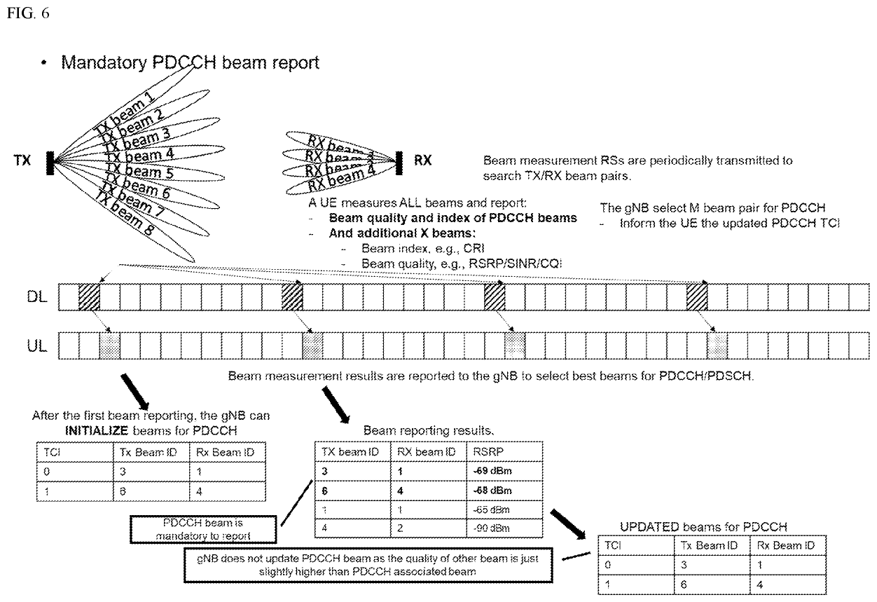

FIG. 6 is a diagram showing a method of restricted beam reporting according to one or more embodiments of a first example of the present invention. As shown in FIG. 6, the BS 20 (TX) includes TX beams 1-8 and the UE 10 (RX) includes RX beams 1-4. The number of TX and RX beams may be at least one.

A beam management scheme according to one or more embodiments of the first example of the present invention will be described below. The BS 20 may transmit RSs (e.g., CSI-RSs) periodically to search TX/RX beam pair links.

In an initial state, the BS 20 manages at least a predetermined beam pair link used for PDCCH transmission by associating a Transmission Configuration Indication (TCI) with the beam pair link. The TCI identifies each beam pair link. In an example of FIG. 6, in the initial state, the beam pair links used for the PDCCH transmission are a pair of TX beam ID “3” and RX beam ID “1” and a pair of TX beam ID “6” and RX beam ID “4.” For example, the BS 20 may select the beam pair link(s) used for the PDCCH transmission based on beam reporting from the UE 10. For example, the BS 20 may notify the UE 10 of the selected beam pair link(s).

The BS 20 may transmit the RSs using the TX beams of TX beam IDs 1-8. The UE 10 may receive the RSs from the BS 20 using the RX beams of RX beam IDs 1-4.

The UE 10 may measure quality of each of pairs of the TX beams and the RX beams. Then, the UE 10 may perform beam reporting based on the measurement quality. In the beam reporting, the UE 10 may report quality of beams and beam indexes that identify each of the beams to be reported. According to one or more embodiments of the first example of the present invention, the quality of beams to be reported includes quality of beams used for the PDCCH transmission and at least one beam other than the beams used for the PDCCH transmission. For example, the UE 10 may select the beam(s) other than the beams used for the PDCCH transmission having the best-M quality. That is, quality of the beams to be reported other than the beams used for the PDCCH transmission may be better than quality of other beams.

In one or more embodiments of the present invention, the quality of beams may be Reference Signal Received Power (RSRP), Reference Signal Received Quality (RSRQ), Signal-to-Interference-plus-Noise Ratio (SINR), Channel Quality Indicator (CQI), or Channel State Information (CSI).

When the BS 20 receives the beam report, the BS 20 may update beams used for the PDCCH transmission based on the quality reported by the UE 10. For example, the BS 20 may update the managed beams used for the PDCCH transmission if the reported quality of the beam other than the beams used for the PDCCH transmission is higher than quality of the current managed beams used for the PDCCH transmission. As another example, the BS 20 may not update the managed beams used for the PDCCH transmission if the reported quality of the beam other than the beams used for the PDCCH transmission is slightly higher (e.g., 1-4 dBm) or is not higher than quality of the current managed beams used for the PDCCH transmission. When the BS 20 updates the managed beams, the BS 20 may notify the UE 10 of the updated beam(s) (beam pair link(s)).

As such, optimal beam selection causes the BS 20 (gNB) to receive information of both PDCCHs associated beams and other beams. Furthermore, overhead can be reduced by reporting only partial beams.

Thus, according to one or more embodiments of the first example of the present invention, the UE 10 may receive, from the BS 20, multiple RSs using beams (first beams). The beams (first beams) include at least one beam used for the PDCCH transmission (second beam) and beams that are not used for the PDCCH transmission (third beams). The UE 10 may measure quality of the beams (first beams). The UE 10 may report, to the BS 20, the quality of at least one beam used for the PDCCH transmission (second beam) and part of the beams that are not used for the PDCCH transmission (third beams).

According to one or more embodiments of the first example of the present invention, TX beams (first beams) may be used for transmission from the BS. The UE 10 receives the RSs using beams used for reception at the UE (fourth beams), which are RX beams. The UE 10 measures the quality in each of pairs of the TX beams and the RX beams.

According to one or more embodiments of the first example of the present invention, the RX beams include at least one beam used for the PDCCH transmission (fifth beam) and beams that are not used for the PDCCH transmission (sixth beam). The UE 10 reports quality of each of pairs of the at least one TX beam and the at least one RX beam that are used for the PDCCH transmission. The UE 10 further reports quality of part of pairs of the TX beams and the RX beams that are not used for the PDCCH transmission.

### Second Example: Restricted Beam Reporting

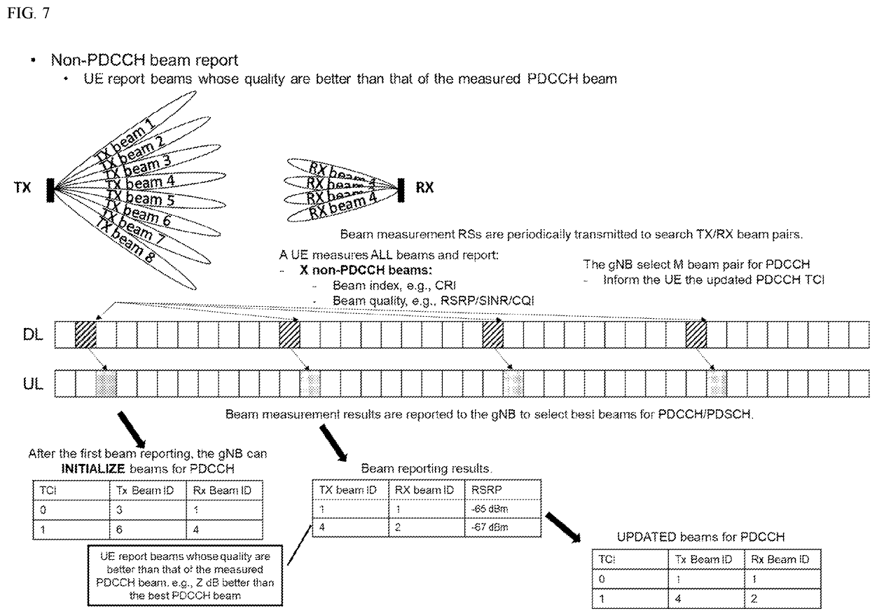

FIG. 7 is a diagram showing a method of restricted beam reporting according to one or more embodiments of a second example of the present invention. As shown in FIG. 7, the BS 20 (TX) includes TX beams 1-8 and the UE 10 (RX) includes RX beams 1-4. The number of TX and RX beams may be at least one.

A beam management scheme according to one or more embodiments of the second example of the present invention will be described below. The BS 20 may transmit RSs (e.g., CSI-RSs) periodically to search TX/RX beam pair links.

In an initial state, the BS 20 manages at least a predetermined beam pair link used for PDCCH transmission by associating a Transmission Configuration Indication (TCI) with the beam pair link. The TCI identifies each beam pair link. In an example of FIG. 7, in the initial state, the beam pair links used for the PDCCH transmission are a pair of TX beam ID “3” and RX beam ID “1” and a pair of TX beam ID “6” and RX beam ID “4.” For example, the BS 20 may select the beam pair link(s) used for the PDCCH transmission based on beam reporting from the UE 10. For example, the BS 20 may notify the UE 10 of the selected beam pair link(s).

The BS 20 may transmit the RSs using the TX beams of TX beam IDs 1-8.

The UE 10 may receive the RSs from the BS 20 using the RX beams of RX beam IDs 1-4.

The UE 10 may measure quality of each of pairs of the TX beams and the RX beams. Then, the UE 10 may perform beam reporting based on the measurement quality. In the beam reporting, the UE 10 may report quality of beams and beam indexes that identify each of the beams to be reported. According to one or more embodiments of the second example of the present invention, the quality of beams to be reported includes quality at least one beam other than the beams used for the PDCCH transmission. For example, the UE 10 may select the beam(s) other than the beams used for the PDCCH transmission having the best-M quality. That is, quality of the beams to be reported other than the beams used for the PDCCH transmission may be better than quality of other beams.

In a similar manner to the first example, the BS 20 may update beams used for the PDCCH transmission based on the quality reported by the UE 10.

As such, optimal beam selection causes the UE 10 to report only beams with better quality than the PDCCH beam. Furthermore, overhead can be reduced by reporting only partial beams.

Thus, according to one or more embodiments of the second example of the present invention, the UE 10 receives, from the BS 20, multiple RSs transmitted using beams (first beams). The beams (first beams) includes at least one beam used for the PDCCH transmission (second beam) and beams that are not used for the PDCCH transmission (third beams). The UE 10 measures quality of the beams (first beams). The UE 10 reports, to the BS 20, the quality of part of the beams that are not used for the PDCCH transmission (third beams).

(Further Enhancements)

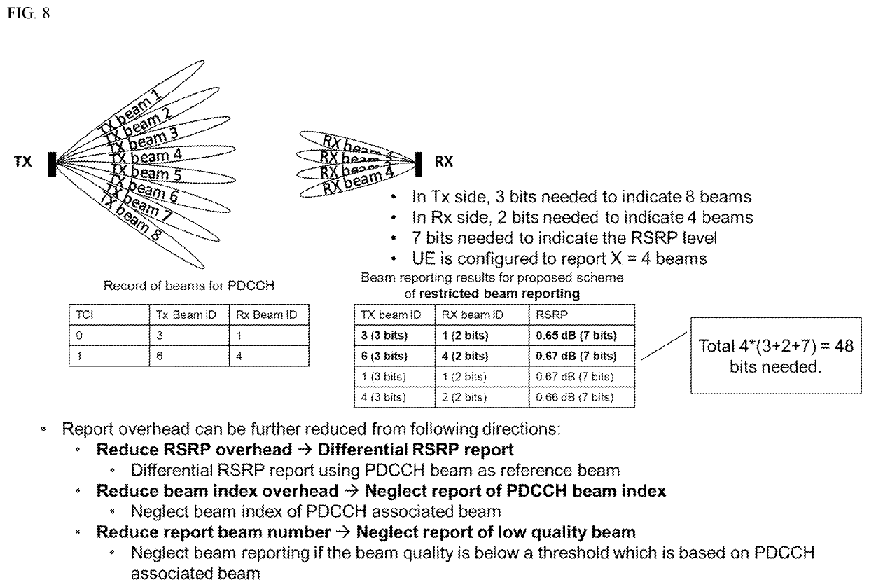

FIG. 8 shows further enhancements of beam reporting in the proposed scheme.

(Enhanced Scheme 1: Differential Report Based on Beam for PDCCH Transmission)

In one or more embodiments of the first and second examples of the present invention, differential beam quality reporting may be applied using quality of beams used for the PDCCH transmission as quality reference for differential quality reporting.

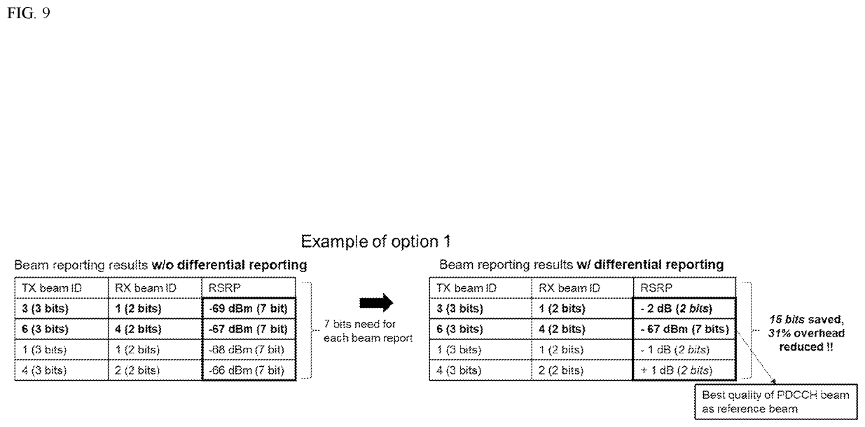

In Option 1 of the enhanced scheme 1, the reference quality may be the highest or lowest quality of the beams used for the PDCCH transmission as shown in FIG. 9.

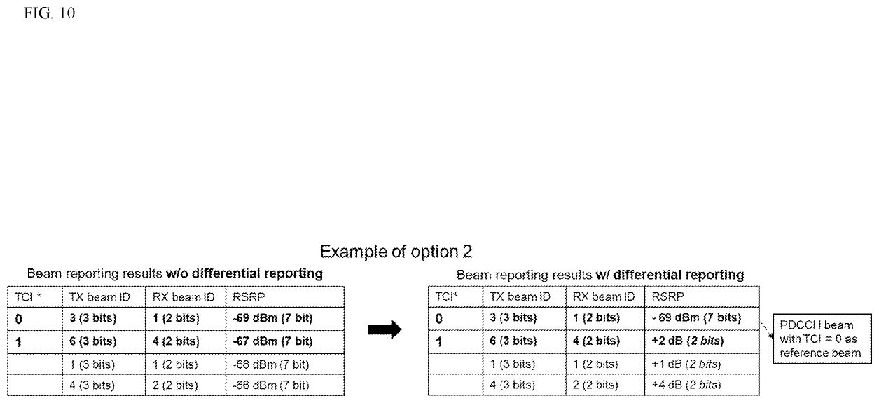

In Option 2 of the enhanced scheme 1, the reference quality may be the L1-RSRP of one beam used for the PDCCH transmission with specific order (e.g., TCI order) as shown in FIG. 10.

(Enhanced Scheme 2: Neglect Report of PDCCH Beam Index)

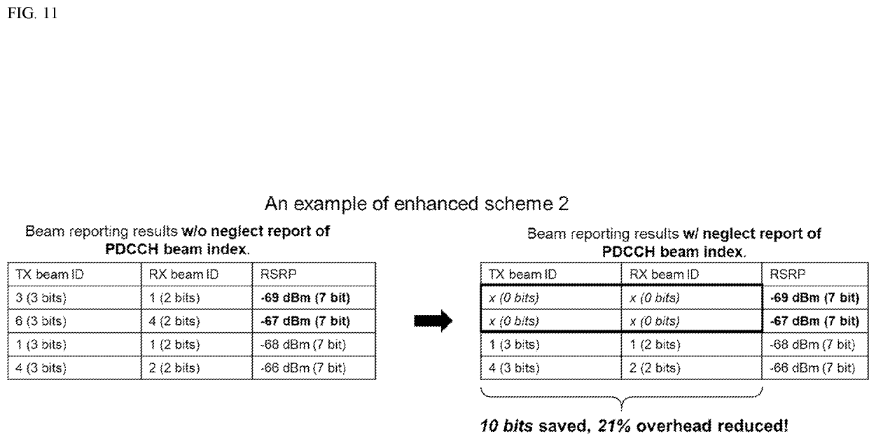

In an enhanced scheme 2 according to one or more embodiments of the present invention, unnecessary reporting may be omitted and beam index reporting for the beam used for the PDCCH transmission may be neglected as shown in FIG. 11. For example, a beam index may not be reported as both of the gNB and the UE 10 have knowledge of beams for the PDCCH, and the UE 10 may report the RSRP value only in specific order that is a common assumption between the UE 10 and the BS 20 (e.g., TCI).

(Enhanced Scheme 3: Neglect Report of Low Quality Beam)

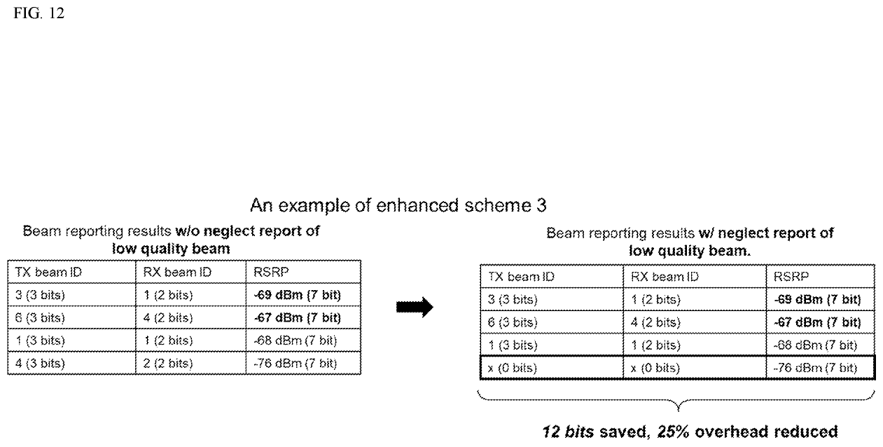

In an enhanced scheme 3 according to one or more embodiments of the present invention, unnecessary reporting for beams that are not used of the PDCCH transmission (non-PDCCH associated beam) may be omitted and beam reporting may be neglected if the beam quality is below a predetermined threshold as shown in FIG. 12.

In Option 1 of the enhanced scheme 3, a predetermined threshold value may be a value of the lowest quality of the current beam used for the PDCCH transmission.

In Option 2 of the enhanced scheme 3, a predetermined threshold value may be a quality of the lowest quality of the current beam used for the PDCCH transmission+Z dB. For example, assuming that Z is 2 dB, the beam may not be reported if the RSRP of the beam is 1 dB higher than the lowest beam used for the PDCCH transmission.

Thus, the quality of the beams that are not used for the PDCCH transmission may be greater than or equal to a predetermined threshold value.

(Enhanced Scheme 3a: Neglect Report of PDCCH Beam Quality)

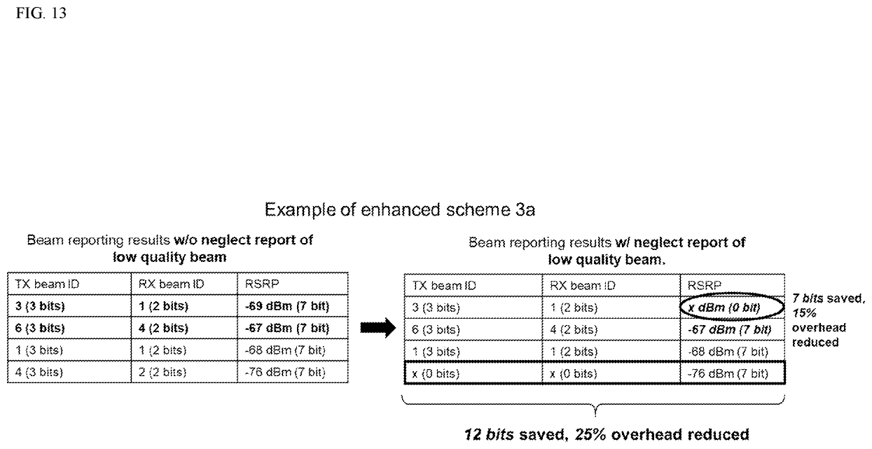

In an enhanced scheme 3a according to one or more embodiments of the present invention, unnecessary reporting for the beam that are not used for the PDCCH transmission may be omitted and beam index reporting for the beam used for the PDCCH transmission may be neglected as shown in FIG. 13. For example, the beam quality may not be reported for the beam used for the PDCCH transmission. The beam index may be omitted for a single beam used for the PDCCH.

In the enhanced scheme 3a, for the beam that are not used for the PDCCH transmission, beam reporting may be neglected if the beam quality is below a predetermined threshold.

In Option 1 of the enhanced scheme 3a, the predetermined threshold may be the quality of one PDCCH beam.

In Option 2 of the enhanced scheme 3a, the predetermined threshold may be the quality of one PDCCH beam+Z dB. For example, assuming that Z is 2 dB, the beam may not be reported if the RSRP of the beam is 1 dB higher than the lowest beam used for the PDCCH transmission.

(Enhanced Scheme 3b: Positive Only Differential Report)

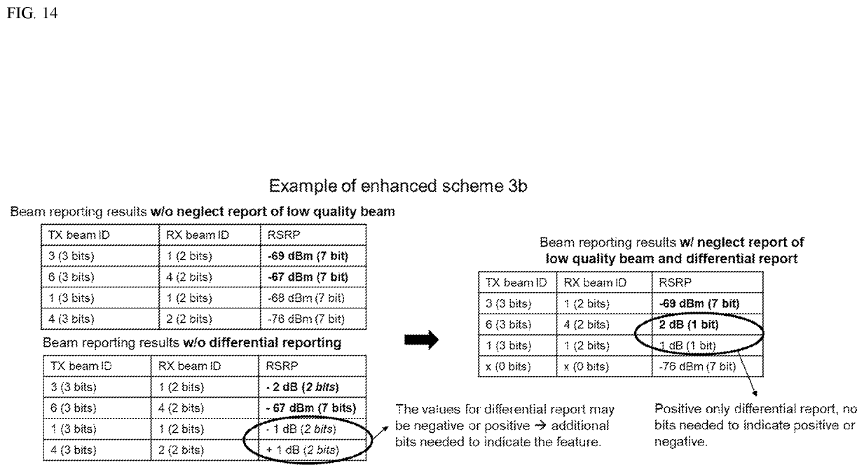

An enhanced scheme 3b may be a scheme where the enhanced scheme 1 (differential reporting based on PDCCH beam) may be combined with the enhanced scheme 3 (neglect reporting of low quality beam) as shown in FIG. 14.

In the enhanced scheme 3b, for example, the lowest or highest quality of the beam used for the PDCCH transmission may be set as the reference beam for differential report.

For example, the lowest quality of the beam used for the PDCCH transmission may be set as the threshold for neglecting report of low quality beam.

For example, the index of the reference beam can be informed, e.g., beam pair link index or TCI.

In the restricted beam reporting, the UE 10 always reports at least one of the beams used for the PDCCH transmission and best-Y beams that are not associated with the current PDCCH transmission

In the aforementioned restricted beam reporting scheme, differential beam quality reporting may be applied using quality of the beam used for the PDCCH transmission as a beam quality reference and differential quality reporting for beams that are not used for the PDCCH transmission may be provided.

For the restricted beam reporting scheme, unnecessary reporting for the beam used for the PDCCH transmission may be omitted and the beam index is ignored.

For the restricted beam reporting scheme, unnecessary reporting for the beam used for the PDCCH transmission may be omitted and the beam quality may be ignored.

For the aforementioned restricted beam reporting scheme, unnecessary reporting for the beam that are not used for the PDCCH transmission may be omitted and the beam reporting may be ignored if the beam quality is below a threshold. The threshold may be the lowest quality of beams used for the PDCCH transmission.

In the restricted beam reporting, selecting the beam to be reported may be conditioned on the quality of the beam used for the PDCCH transmission without reporting anything related to beams used for the PDCCH transmission.

For the restricted beam reporting, quality of the reported beams is better than that of the measured beam used for the PDCCH transmission.

Based on the restricted beam reporting, when quality of the beam used for the PDCCH transmission degrades a lot, e.g., lower than a specific threshold, the UE 10 can assume that the BS 20 will not transmit Downlink Control Information (DCI) on this beam and neglect the DCI associated to that beam, and following other examples may be assumed for DCI demodulation.

For example, the beam used for the PDCCH transmission may be on a per CORESET basis.

For example, the beam used for the PDCCH transmission may be on a search space basis.

In the restricted beam reporting, the UE 10 may always report for the beams used for the PDCCH transmission and report in addition best-Y beams that are not associated with the current PDCCH transmission.

The value of Y is configurable or fixed. If configurable, Y is configured by the BS 20 with Radio Resource Control (RRC) and/or MAC Control Element (MAC CE) signaling and/or DCI signaling. Y may be zero.

For beam index reporting, the UE 10 can report TX beam index only without reporting Rx beam index. The UE 10 can report RX beam index only without reporting Tx beam index. The UE 10 can report both TX beam and Rx beam index.

The beam index mentioned above can be CSI-RS resource indicator, SS block index, and other indicator referred to a specific RS resource or RS resource set.

The beam used for the PDCCH transmission mentioned in this proposal can be the beam whose index is configured to a TCI state.

Transmission Configuration Indication (TCI) is configured by the BS 20 at least for the QCL indication.

The above methods according to embodiments of the present invention can be used together or separately.

For example, one combined method may be, report differential RSRP and do not report the CRI, for beam reporting of the beam used for the PDCCH transmission.

The method can also be applicable for other channels, e.g., PDSCH.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A user equipment (UE) comprising:
a receiver that receives, from a base station (BS), multiple reference signals transmitted using first beams, wherein the first beams comprise at least one second beam used for Physical Downlink Control Channel (PDCCH) transmission between the BS and the UE and third beams that are not used for the PDCCH transmission;
a processor that measures quality of the first beams; and
a transmitter that reports, to the BS, the quality of the at least one second beam and part of the third beams.

2. The UE according to claim 1,
wherein the first beams are used for transmission from the BS,
wherein the receiver receives the reference signals using fourth beams used for reception at the UE, and
wherein the processor measures the quality in each of pairs of the first beams and the fourth beams.

3. The UE according to claim 2,
wherein the fourth beams comprise at least one fifth beam used for the PDCCH transmission and sixth beams that are not used for the PDCCH transmission, and
wherein the transmitter reports:
quality of each of pairs of the at least one second beam and the at least one fifth beam; and
quality of part of pairs of the third beams and the sixth beams.

4. The UE according to claim 1, wherein the quality of the part of third beams is higher than quality of beams other than the part of the third beams.

5. The UE according to claim 1, wherein the quality is Reference Signal Received Power (RSRP).

6. The UE according to claim 1, wherein the transmitter reports the quality and a beam index that identifies each of the at least one second beam and the part of third beams.

7. The UE according to claim 1, wherein the transmitter reports the quality that is represented as a differential value from a quality value of the at least one second beam.

8. The UE according to claim 1, wherein the quality of the part of third beams is greater than or equal to a predetermined threshold value.

9. The UE according to claim 8, the predetermined threshold value is a lowest quality value of the at least one second beam.

10. A user equipment (UE) comprising:
a receiver that receives, from a base station (BS), multiple reference signals transmitted using first beams, wherein the first beams comprise at least one second beam used for Physical Downlink Control Channel (PDCCH) transmission between the BS and the UE and third beams that are not used for the PDCCH transmission;
a processor that measures quality of the first beams; and
a transmitter that reports, to the BS, the quality of part of the third beams.

11. The UE according to claim 10,
wherein the first beams are used for transmission from the BS,
wherein the receiver receives the reference signals using fourth beams used for reception at the UE, and
wherein the processor measures the quality in each of pairs of the first beams and the fourth beams.

12. The UE according to claim 11,
wherein the fourth beams comprise at least one fifth beam used for the PDCCH transmission and sixth beams that are not used for the PDCCH transmission, and
wherein the transmitter reports quality of part of pairs of the third beams and the sixth beams.

13. The UE according to claim 10, wherein the quality of the part of third beams is higher than quality of beams other than the part of the third beams.

14. The UE according to claim 10, wherein the quality is Reference Signal Received Power (RSRP).

15. The UE according to claim 10, wherein the transmitter reports the quality and a beam index that identifies each of the part of third beams.

16. The UE according to claim 10, wherein the quality of the part of third beams is greater than or equal to a predetermined threshold value.

17. The UE according to claim 16, the predetermined threshold value is a lowest quality value of the at least one second beam.
